(19) United States
(12) Patent Application Publication
(10) Pub. No.: US 2013/0113361 A1
(43) Pub. Date: May 9, 2013

(54) AUXILIARY AMALGAM FOR A LOW PRESSURE DISCHARGE LAMP

(71) Applicants: Ottokar GYULASI, Budapest (HU); Peter LUCZ, Budapest (HU); Peter Ivan POCZIK, Budapest (HU); Balazs Torok, Budapest (HU)

(72) Inventors: Ottokar GYULASI, Budapest (HU); Peter LUCZ, Budapest (HU); Peter Ivan POCZIK, Budapest (HU); Balazs Torok, Budapest (HU)

(73) Assignee: GENERAL ELECTRIC COMPANY, Schenectady, NY (US)

(21) Appl. No.: 13/292,150

(22) Filed: Nov. 9, 2011

(51) Int. Cl. H01J 61/44; C09K 11/08; C09K 11/54; H01J 9/22

(52) U.S. Cl. 313/490; 445/58; 252/301.4 R; 252/301.6 R

(57) ABSTRACT

A low-pressure discharge lamp includes, in an exemplary embodiment, a light-transmissive envelope, a fill-gas composition capable of sustaining a discharge sealed inside the light-transmissive envelope, and a phosphor composition at least partially disposed on an interior surface of said light-transmissive envelope forming at least one phosphor layer. The phosphor composition includes at least one phosphor, and at least one amalgam-forming material.

### BACKGROUND OF THE INVENTION

The present disclosure relates generally to a low pressure mercury vapor discharge lamp and more particularly to a low pressure mercury vapor discharge lamp that includes an auxiliary amalgam integrated into the phosphor coating of the lamp.

A wide variety of low-pressure discharge lamps are known in the art. Low pressure mercury vapor discharge lamps have a high efficiency of converting supplied electrical energy into ultraviolet radiation at an optimal mercury vapor pressure. The mercury vapor pressure is typically very highly dependent on the operating temperature of the lamp. Some types of compact fluorescent lamps, which may have bent tubes forming convoluted discharge paths, or spiral or other possible shapes by design, can have high wall load and therefore a high temperature at the walls and some applications may also increase the wall temperature typically from about 70° C. to about 140° C. At these high temperatures the vapor pressure of the mercury can increase above the optimal.

To control the mercury vapor pressure near the optimal level, an amalgam is used in place of conventional liquid mercury. As the temperature and, therefore, the mercury vapor pressure in the lamp increases, the amalgam begins to melt and form a solution with mercury vapor to adjust the mercury vapor pressure in the lamp back toward the optimal level. The location of the amalgam, which has a predetermined melting temperature, is important in providing the desired mercury vapor pressure because the location of the amalgam affects its temperature during operation of the lamp. The amalgam typically used in areas near high temperature walls is bismuth-indium-mercury (Bi—In—Hg).

Lamps using an amalgam optimized for use in high temperature areas have the disadvantage of a longer warm-up or starting period than lamps using pure liquid mercury. The length of the starting period is dependent on the speed at which the mercury vapor pressure in the lamp increases because the lumen output of the lamp is dependent on the mercury vapor pressure in the lamp. The starting period is longer for amalgam containing lamps because the mercury vapor pressure is too low at lower temperatures usually present at start-up, typically in the range of about 0 degrees C. to about 50 degrees C. The mercury vapor pressure increases slowly and doesn't reach its proper level until the amalgam reaches the high temperatures. In contrast, the mercury vapor pressure of a liquid mercury dosed lamp is much higher than the mercury vapor pressure of the amalgam containing lamp at the lower temperature or at room temperature.

To improve warm-up characteristics of an amalgam containing lamp, an auxiliary amalgam may be attached to each electrode stem so that the auxiliary amalgam emits mercury during the starting period. The auxiliary amalgam is heated by the cathode after ignition and emits mercury vapor to make up for the lack of mercury vapor during the starting period. The auxiliary amalgam typically used is indium-mercury (In—Hg). The amalgam which controls the mercury vapor pressure during operation, except for the starting period, is typically called the main amalgam, in contrast with the auxiliary amalgam which controls the mercury vapor pressure during the starting period.

Amalgams containing low pressure mercury vapor discharge lamps have experienced varying degrees of success. Thus, a need exists for an improved low-pressure mercury vapor discharge lamp having improved warm-up characteristics.

### BRIEF DESCRIPTION OF THE INVENTION

In one aspect, a low-pressure discharge lamp is provided The low-pressure discharge lamp includes a light-transmissive envelope, a fill-gas composition capable of sustaining a discharge sealed inside the light-transmissive envelope, and a phosphor composition at least partially disposed on an interior surface of said light-transmissive envelope forming at least one phosphor layer. The phosphor composition includes at least one phosphor, and at least one amalgam-forming material.

In another aspect, a phosphor composition is provided. The phosphor composition includes at least one phosphor, and at least one amalgam-forming material.

In another aspect, a method of making a low-pressure discharge lamp is provided. The low-pressure discharge lamp includes a light-transmissive envelope. The method includes blending at least one phosphor and at least one amalgam-forming material to form a phosphor composition, and coating an inner surface of the light-transmissive envelope with the phosphor composition to form a phosphor layer.

### BRIEF DESCRIPTION OF THE DRAWINGS

FIG. 1 is a perspective view partially broken away of a low pressure mercury discharge lamp construction having a phosphor coating in accordance with an exemplary embodiment.

FIG. 2 is a graph of the run-up time of the low pressure mercury discharge lamp shown in FIG. 1 as compared to a comparison low pressure mercury discharge lamp.

### DETAILED DESCRIPTION OF THE INVENTION

A low pressure mercury discharge lamp that includes an auxiliary amalgam integrated into the phosphor coating applied to the light-transmissive envelope of the discharge lamp is described below in detail. Integrating the auxiliary amalgam into the phosphor layer of the discharge lamp provides for the auxiliary amalgam to be positioned throughout the length of the light-transmissive envelope which permits the mercury to quickly diffuse throughout the envelope. This creates a faster run up of the light output of the discharge lamp as compared to known discharge lamps.

The phosphor coating material includes at least one phosphor and at least one amalgam-forming material. The amalgam-forming material may be a particulate indium metal, e.g., indium powder having a average size of between about 5 micrometers (gm) to about 80 gm. Typically, the at least one phosphor material may be a blend of phosphors with each phosphor emitting different colors than each other phosphor, or the same color of one or more phosphor in the blend. The amalgam-forming material particles are blended with the phosphor particles to form the phosphor coating material.

As generally known, a “phosphor” is a luminescent material that absorbs radiation energy in a portion of the electromagnetic spectrum and emits energy in another portion of the electromagnetic spectrum. One important class of phosphors are crystalline inorganic compounds of high chemical purity and of controlled composition to which small quantities of other elements (called “activators”) have been added to convert them into efficient luminescent materials. Phosphors are used in low pressure (e.g., mercury vapor) discharge lamps to convert ultraviolet (“UV”) radiation emitted by the excited mercury vapor to visible light.

The description below describes a low pressure mercury discharge fluorescent lamp that includes a sealed light-transmissive envelope having a circular cross section for describing an exemplary embodiment. However, it is contemplated to be within the scope of the disclosure to make and use the lamps disclosed herein, in a wide variety of types, including mercury fluorescent lamps, low dose mercury, and very high output fluorescent. The lamp may include electrodes or may be electrodeless. The lamp may be linear, but any size shape or cross section may be used. It may be any of the different types of fluorescent lamps, such as T5, T8, T12, 17 W, 20 W, 25 W, 32 W, 40 W, 54 W, 56 W, 59 W, 70 W, linear, circular, 2D, twin tube or U-shaped fluorescent lamps. The lamps may be high-efficiency or high-output fluorescent lamps. For example, embodiments may include lamps that are curvilinear in shape, as well as compact fluorescent lamps as are generally familiar to those having ordinary skill in the art. Compact fluorescent lamps (CFL's) have a folded or wrapped topology so that the overall length of the lamp is much shorter than the unfolded length of the glass tube. The varied modes of manufacture and configurations for linear as well as compact fluorescent lamps are generally known to persons skilled in the field of low pressure discharge lamps.

The lamp described below is a low-pressure discharge lamp (e.g., fluorescent). Such lamp typically includes at least one light-transmissive envelope which can be made of a vitreous (e.g., glass) material and/or ceramic, or any suitable material which allows for the transmission of at least some visible light. A fill-gas composition capable of sustaining an electric discharge is sealed inside the at least one light-transmissive envelope. The lamp also includes at least one phosphor layer, and one or more electrical leads at least partially disposed within the at least one light-transmissive envelope for providing electric current.

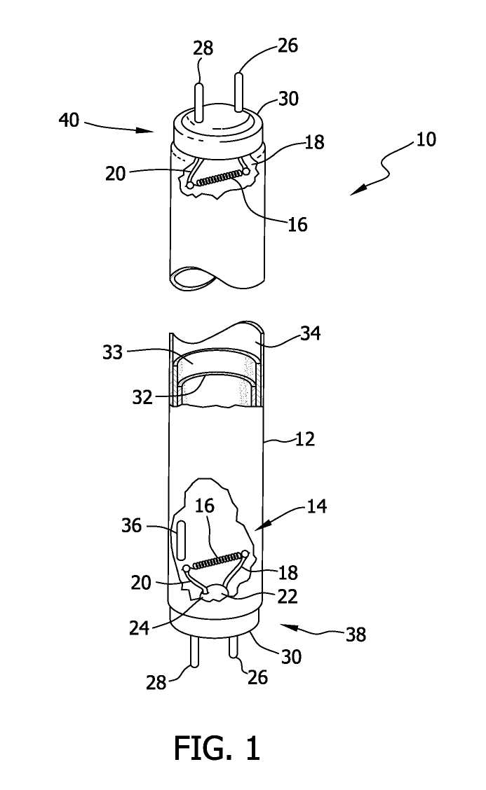

Referring to the drawings, FIG. 1 is a perspective view partially broken away of a low pressure mercury discharge lamp 10 that includes a sealed light-transmissive envelope 12 having a circular cross section. A low pressure mercury discharge assembly 14 in lamp 10 includes a conventional electrode structure 16 at each end connected to lead-in wires 18 and 20 which extend through a glass press seal 22 in a mount stem 24 to electrical contacts 26 and 28 of a base 30 fixed at both ends of sealed light-transmissive envelope 12. The discharge-sustaining filling in sealed light-transmissive envelope 12 may be an inert gas, for example, argon, xenon, neon or krypton at a low pressure in combination with mercury vapor to provide the low vapor pressure for lamp operation. A phosphor layer 32 is disposed on an inner surface 34 of light-transmissive envelope 12. Phosphor layer 32 may include one or more phosphor layers. By “disposed on inner surface 34” is meant to possibly include intervening layers such as barrier layers between inner surface 34 and phosphor layer 32. Often fluorescent lamps may have a layer of a non-luminescent barrier material, such as alumina, which is directly on the inner surface of the glass envelope, to absorb/reflect any escaping UV and to homogenize the appearance of the visible white light escaping. So, “disposed” can be directly on the interior surface, or more usually, with one or more intervening layers such as a barrier layer. In the exemplary embodiment discharge lamp 10, shown in FIG. 1, also includes a non-luminescent barrier layer 33 positioned between inner surface 34 of light-transmissive envelope 12 and phosphor layer 32.

A main amalgam member 36 is positioned in light-transmissive envelope 12 and may be located in the first and/or second ends 38 and 40. The amalgam may be a metal alloy such as an alloy containing a bismuth-indium-mercury (Bi—In—Hg) composition. The main amalgam may also contain tin, zinc, silver, gold or combinations thereof. The particular composition is chosen to be compatible with the operating temperature characteristic of the location in light-transmissive envelope 12. The main amalgam member 36 may include about 0.1 mg of Hg to about 3.0 mg of Hg. In another embodiment, the main amalgam member 36 may include about 0.5 mg of Hg to about 1.0 mg of Hg. As such, the alloy is generally ductile at temperatures of about 100° C. The alloy may become liquid at higher lamp operating temperatures. Once the main amalgam reaches working temperature the mercury vapor pressure during lamp operation stabilizes by absorbing mercury vapor in the amalgam. In other embodiments discharge lamp 10 may include a dose of liquid mercury or amalgams (pellets) of high mercury vapor pressure instead of main amalgam member 36.

An auxiliary amalgam may be used to improve warm-up characteristics of discharge lamp 10 by emitting mercury during the starting period of lamp 10. In an exemplary embodiment, an auxiliary amalgam is integrated into phosphor layer 32 deposited onto light-transmissive envelope 12 of discharge lamp 10. Phosphor layer 32 includes at least one phosphor and at least one amalgam-forming material. The blend of phosphor and amalgam forming material may include a ratio of from about 5 mg to about 90 mg of amalgam-forming material for every 100 g of the blend of phosphors. In another embodiment, the blend of phosphor and amalgam forming material may include a ratio of from about 30 mg to about 80 mg of at least one amalgam-forming material for every 100 g of the blend of phosphors. The amalgam-forming material may be a particulate indium metal, e.g., indium powder having a average size of about 30 micrometers. Typically, the at least one phosphor material may be a blend of phosphors with each phosphor emitting different colors than each other phosphor, or the same color of one or more phosphor in the blend. The amalgam-forming material particles are blended with the phosphor particles to form the phosphor coating material.

The auxiliary amalgam controls the mercury vapor pressure during a starting period of discharge lamp 10. Impacting electrons heat up the auxiliary amalgam and discharge enough to generate mercury vapor during the starting period. Enough vapor is generated to increase the mercury vapor pressure in the discharge lamp and thereby improve warm up characteristics of lamp 10. The auxiliary amalgam also absorbs mercury during non-discharge period, i.e., when the temperature is reduced at the cathode which is in a non-discharge state during this period.

In some embodiments, the amalgam-forming material may include one or more of In, Sn, Bi, Zn, indium oxide, tin oxide, bismuth oxide or zinc oxide. Indium oxide (and the other named oxides) does not by itself form an amalgam with Hg, but can be converted during manufacture and/or operation into indium metal. For example, if one were to mix indium oxide with a phosphor powder, suspend the mixture in a slurry form, coat a lamp envelope, and fire to high temperature to cure the coating, it is possible for some indium oxide to decompose into indium metal. Alternatively, it is possible that at least some indium oxide may decompose to release a “true” amalgam-forming metal after lamp operation. Other methods are also possible. The amalgam-forming material may be a solid which is capable of forming an amalgam upon reaction with Hg and capable of releasing Hg upon decomposition.

In one embodiment, phosphor layer 32 may include at least one halophosphor, and may include at least one rare earth phosphor. In another embodiment, phosphor layer 32 includes at least one halophosphor, and does not include any rare earth phosphors. In other embodiments, phosphor layer 32 is a blend of at least one halophosphor (e.g., two or more halophosphors such as alkaline metal phosphors), and at least one rare earth phosphor. Phosphor layer 32 may also include one or more phosphors which are not rare earth phosphors and which may not be strictly halophosphors. Examples of such may include zinc silicate, strontium red, strontium blue, and the like. As used herein, the term “halophosphor” is intended to refer to a phosphor which includes at least one halogen component (preferably chlorine or fluorine, or a mixture thereof) but which is not activated by a rare earth element. Chemically, a halophosphor may be a phosphate or halophosphate of an alkaline earth metal. Some examples of halophosphate-containing halophosphors may be calcium halophosphates, strontium halophosphates, and barium halophosphate. In some cases, calcium halophosphate halophosphors may have part of calcium (Ca) substituted by strontium (Sr) and/or barium (Ba). Usually, calcium halophosphate halophosphors may be activated by a transition metal element and/or a main group element, such as one or more of manganese (Mn) and antimony (Sb). An example of a formula for a doped calcium halophosphate is: Ca₁₀(PO₄)₆(F,Cl)₂:Sb,Mn. The actual color of this phosphor when irradiated by UV light can be white, but this may be varied depending on the actual amount of Sb, Mn, fluorine (F), and chlorine (Cl). If one of these four elements are omitted, more drastic effects occur. For example, if no Mn is present (i.e., the formula would be simply Ca₁₀(PO₄)₆(F,Cl)₂:Sb), then the phosphor emits only in the blue region. This latter is referred to as “blue halo” phosphor.

A halophosphor may emit a color upon excitation, or may emit light which is perceived to be white. An example of a blue or blue-green emitting halophosphor may include a calcium halophosphate (e.g, fluorophosphate) activated with antimony (3+). An example of a white-emitting halophosphor (e.g., white halo) may include a calcium fluoro-, chloro phosphate activated with antimony (3+) and manganese (2+), such as Ca_{5-x-y}(PO₄)₃F_{1-z-y}Cl_{z}O_{y}:MnₓSb_{y}. Also, a red phosphor (europium-doped yttrium oxide) may be added to white halo to form a regal white halo. Other non-rare-earth-activated phosphors may include one or more of strontium red (e.g., (Sr,Mg)₃(PO₄)₂:Sn) and strontium blue (e.g., Sr₁₀(PO₄)₆F₂:Sb,Mn).

When reciting the chemical formulae for phosphors, the element(s) following the colon represents activator(s). If two or more elements are present after the colon, they are generally both present as activators. As used herein throughout this disclosure, the term “doped” is equivalent to the term “activated”. The various phosphors of any color described herein can have different elements enclosed in parentheses and separated by commas, such as in (Ba,Sr,Ca)MgAl₁₀O₁₇:Eu²⁺,Mn²⁺ phosphor. As would be understood by anyone skilled in the art, the notation (A,B,C) signifies (AₓB_{y}C_{z}) where 0≦x≦1 and 0≦y≦1 and 0≦z≦1 and x+y+z=1. For example, (Sr,Ca,Ba) signifies (SrₓCa_{y}Ba_{z}) where 0≦x≦1 and 0≦y≦1 and 0≦z≦1 and x+y+z=1. Typically, but not always, x, y, and z are all nonzero. The notation (A,B) signifies (AₓB_{y}) where 0≦x≦1 and 0≦y≦1 and x+y=1. Typically, but not always, x and y are both nonzero.

Phosphor layer 32 may include multiple rare earth phosphors. For example, in one embodiment, phosphor layer 32 includes a red-emitting rare earth phosphor, a green-emitting rare earth phosphor, and a blue-emitting rare earth phosphor. In other embodiments, phosphor layer 32 includes a red-emitting rare earth phosphor and a green-emitting rare earth phosphor, or phosphor layer 32 includes a red-emitting rare earth phosphor and a blue-emitting rare earth phosphor, or phosphor layer 32 includes a green-emitting rare earth phosphor and a blue-emitting rare earth phosphor. In another, phosphor layer 32 may also include at least one halophosphor in addition to the at least two rare earth phosphors. In the another embodiment, the phosphor layer 32 does not include any halophosphors.

Phosphor layer 32 may include a red-emitting rare earth phosphor. A red-emitting rare earth phosphor may comprise one or more of: a europium-doped yttrium oxide (e.g., YEO); a europium-doped yttrium vanadate-phosphate (e.g., Y(P,V)O₄:Eu); a metal pentaborate doped with at least cerium (e.g., CBM); or the like. Other possible red rare earth phosphors may include Eu-activated yttrium oxysulfide, or europium(III)-doped gadolinium oxides and borates, such as (Y,Gd)₂O₃:Eu³⁺ and (Y,Gd)BO₃:Eu³⁺. A possible formula for the europium-doped yttrium oxide phosphor may be generally (Y₍₁₋ₓ₎Euₓ)₂O₃, where 0<x<0.1, possibly, 0.02<x<0.07, for example, x=0.06. Such europium-doped yttrium oxide phosphors are often abbreviated YEO (or sometimes YOX or YOE). A possible metal pentaborate doped with at least cerium can have formula (Gd(Zn,Mg)B₅O₁₀:Ce³⁺,Mn²⁺(CBM).

Phosphor layer 32 may include a green-emitting rare earth phosphor. A green-emitting rare earth phosphor may comprise one or more of: a cerium- and terbium-coactivated phosphor (e.g., LAP or CAT); or a europium- and manganese-coactivated magnesium aluminate (e.g., BAMn); or CBT; or the like. A cerium- and terbium-doped phosphor may be a cerium- and terbium-doped lanthanum phosphate. Typical formulae for cerium- and terbium-doped lanthanum phosphate may include one selected from: LaPO₄:Ce,Tb; LaPO₄:Ce³⁺,Tb³⁺; or (La,Ce,Tb)PO₄. Specific cerium- and terbium-doped lanthanum phosphate phosphors in accordance with embodiments of the invention may have the formula (La_{(1-x-y)}CeₓTb_{y})PO₄, where 0.1<x<0.6 and 0<y<0.25 (or possibly, 0.2<x<0.4; 0.1<y<0.2) (LAP). Other cerium- and terbium-doped phosphor may be (Ce,Tb)MgAl₁₁O₁₉ (CAT) ; and (Ce,Tb)(Mg,Mn)Al₁₁O₁₉. It is possible for BAMn to be considered as a green rare-earth phosphor, depending on the molar ratio among its activators.

Phosphor layer 32 may include a blue-emitting rare earth phosphor. A blue-emitting rare earth phosphor may comprise one or more of: a europium-doped halophosphate (e.g., SECA, with typical formula (Sr, Ca, Ba)₅(PO₄)₃Cl:Eu²⁺), a europium-doped magnesium aluminate (e.g., BAM), a europium- and manganese-coactivated magnesium aluminate (e.g., BAMn), a europium-doped strontium aluminate (e.g., SAE), a europium-doped borophosphate, a cerium-doped yttrium aluminate (e.g., YAG); or the like. A europium-doped strontium aluminate may have the formula of Sr₄Al₁₄O₂₅:Eu²⁺ (SAE). In such formula, the europium-doped strontium aluminate phosphor may comprise Sr and Eu in the following atom ratio: Sr_{0.90-0.99}Eu_{0.01-0.1}. BAM may have the formula (Ba,Sr,Ca)MgAl₁₀O₁₇:Eu²⁺. BAMn may have the formula (Ba,Sr,Ca)MgAl₁₀O₁₇:Eu²⁺,Mn²⁺. It is possible for BAMn to be sometimes considered as a blue-green, blue, or green rare-earth phosphor, often depending on the molar ratio among its activators.

Phosphor layer 32 may be applied to inner surface 34 of light-transmissive envelope 12 by any effective method, including known or conventional methods, such as by slurrying. Methods of preparing and applying phosphor coating slurries are generally known or conventional in the art. For example, the components of phosphor layer 32 is coated as a layer directly onto inner surface 34 of light transmissive envelope 12. A phosphor coating suspension is prepared by dispersing the desired phosphor particles in a water-based system that may include binders, for example, polyethylene oxide and hydroxyethyl cellulose, with water as the solvent. The phosphor suspension is applied by causing the suspension to flow down inner surface 34. Evaporation of the water results in an insoluble layer of phosphor particles adhering to inside surface 34 of light transmissive envelope 12. Phosphor layer 32 is dried with heat. If there are more than one phosphor layer 32, each extra phosphor layer is similarly applied from a water based suspension containing the appropriate and desired blend of phosphors. The water base suspension is allowed to flow over the previously applied and dried phosphor layer 32 until the liquid is drained from light transmissive envelope 12.

### EXAMPLE I

A comparative example test comparing the lumen run-up time characteristics of an exemplary sample discharge lamp of an embodiment of the invention designated Sample A, and a control sample discharge lamp designated Sample B. Sample A is a discharge lamp having an auxiliary amalgam integrated into the lamp's phosphor layer as described above. Sample B is a similar discharge lamp which only had a conventional amalgam pellet positioned in the envelope of the lamp.

The phosphor layer of Sample A was formed by blending 30 mg (milligrams) of indium powder (average size of about 40 micrometers) with 100 g (grams) of a phosphor blend that includes phosphor particles of red, green and blue emitting phosphors. A portion of this mixture/blend was coated onto the lamp envelope of Sample A in a conventional manner as described above. The Sample A discharge lamp was dosed with 0.8 mg of Hg added as a conventional amalgam pellet. The phosphor layer of Sample B discharge lamp (not within the scope of the disclosure) was formed by coating a phosphor blend that includes phosphor particles of red, green and blue emitting phosphors (i.e., the same phosphors in the same amount as for Sample A) onto the lamp envelope, but with no indium powder. The Sample B discharge lamp was dosed with 0.8 mg of Hg added as a conventional amalgam pellet.

The test lamp of Sample A and the comparative test lamp of Sample B were tested in newly-constructed form, as well as aged to 1000 hours and 2000 hours, and in each case had essentially the lumen run-up time of Sample A was better than the lumen run-up time of Sample B.

### EXAMPLE II

A comparative example test comparing the lumen run-up time characteristics of an exemplary sample discharge lamp of an embodiment of the invention designated Sample C, and a control sample discharge lamp designated Sample D. Sample C is similar to Sample A and also includes an auxiliary amalgam integrated into the lamp's phosphor layer as described above. Sample D is similar to Sample B discharge lamp but which additionally includes an auxiliary amalgam flag welded onto the mount stem in the envelope of the lamp.

The phosphor layer of Sample C was formed by blending 30 mg (milligrams) of indium powder (average size of about 40 micrometers) with 100 g (grams) of a phosphor blend that includes phosphor particles of red, green and blue emitting phosphors. A portion of this mixture/blend was coated onto the lamp envelope of Sample A in a conventional manner as described above. The Sample C discharge lamp was dosed with 0.8 mg of Hg added as a conventional amalgam pellet. The phosphor layer of Sample D discharge lamp (not within the scope of the disclosure) was formed by coating a phosphor blend that includes phosphor particles of red, green and blue emitting phosphors (i.e., the same phosphors in the same amount as in Sample C) onto the lamp envelope, but with no indium powder. The Sample D discharge lamp was also dosed with 0.8 mg of Hg added as a conventional amalgam pellet, and also includes an auxiliary amalgam flag welded onto the mount stem in the envelope of the lamp.

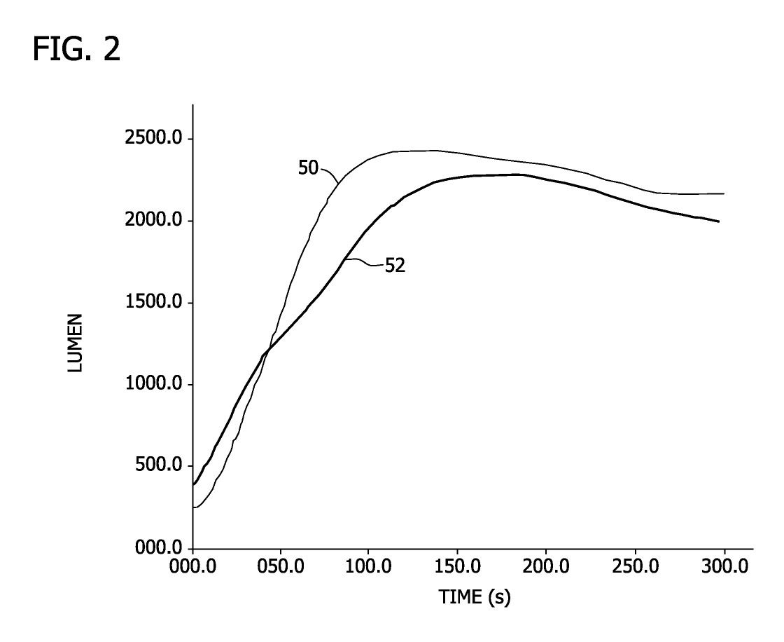

The test lamp of Sample C and the comparative test lamp of Sample D were tested after aging to 100 hours. FIG. 2 is a graph of the amount of light transmission measured as lumens versus time of Sample C and Sample D from 0.0 seconds to 300.0 seconds. Line 50 indicates the lumen run-up time of Sample C and line 52 indicates the lumen run-up of Sample D. Graph lines 50 and 52 indicate that Sample C has a better lumen run-up than the lumen run-up of Sample D.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” used in connection with a quantity is inclusive of the stated value and has the meaning dictated by the context (for example, includes the degree of error associated with the measurement of the particular quantity). “Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present. The singular forms “a”, “an” and “the” include plural referents unless the context clearly dictates otherwise. All ranges disclosed herein are inclusive of the recited endpoint and independently combinable. As used herein, the phrases “adapted to,” “configured to,” and the like refer to elements that are sized, arranged or manufactured to form a specified structure or to achieve a specified result.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A low-pressure discharge lamp, comprising:
a light-transmissive envelope;
a fill-gas composition capable of sustaining a discharge sealed inside said light-transmissive envelope; and
a phosphor composition at least partially disposed on an interior surface of said light-transmissive envelope forming at least one phosphor layer;
said phosphor composition comprising:
at least one phosphor; and
at least one amalgam-forming material.

2. The low-pressure discharge lamp of claim 1 wherein said at least one phosphor comprises a blend of phosphors, each phosphor in said blend of phosphors may emit different colors than each other phosphor in said blend of phosphors, or the same color as one or more phosphors in said blend.

3. The low-pressure discharge lamp of claim 1 wherein said at least one amalgam-forming material comprises a solid which is:
(a) capable of forming an amalgam upon reaction with Hg; and
(b) capable of releasing Hg upon decomposition.

4. The low-pressure discharge lamp of claim 3 wherein said at least one amalgam-forming material comprises a powder.

5. The low-pressure discharge lamp of claim 1 wherein said at least one amalgam-forming material comprises at least one of In, Sn, Bi, Zn, Ag, Au, indium oxide, tin oxide, bismuth oxide, silver oxide, or zinc oxide.

6. The low-pressure discharge lamp of claim 1 wherein said phosphor composition comprises a ratio of from about 5 mg to about 90 mg of amalgam-forming material for every 100 g of phosphor.

7. The low-pressure discharge lamp of claim 1 further comprising one or more auxiliary amalgam structures positioned inside said light-transmissive envelope.

8. The low-pressure discharge lamp of claim 1 further comprising at least one amalgam pellet positioned inside said light-transmissive envelope.

9. A phosphor composition, comprising
at least one phosphor; and
at least one amalgam-forming material.

10. The phosphor composition of claim 9 wherein the at least one phosphor comprises a blend of phosphors, each phosphor in said blend of phosphors may emit different colors than each other phosphor in said blend of phosphors, or the same color as one or more phosphors in said blend.

11. The phosphor composition of claim 9 wherein said at least one amalgam-forming material comprises a solid which is:
(a) capable of forming an amalgam upon reaction with Hg; and
(b) which is capable of releasing Hg upon decomposition.

12. The phosphor composition of claim 11 wherein said at least one amalgam-forming material comprises a powder.

13. The phosphor composition of claim 9 wherein the at least one amalgam-forming material comprises at least one of In, Sn, Bi, Zn, Ag, Au, indium oxide, tin oxide, bismuth oxide, silver oxide, and zinc oxide.

14. The phosphor composition of claim 9 wherein said phosphor composition comprises a ratio of from about 5 mg to about 90 mg of amalgam-forming material for every 100 g of phosphor.

15. A method of making a low-pressure discharge lamp, the low-pressure discharge lamp comprising a light-transmissive envelope, said method comprising:
blending at least one phosphor and at least one amalgam-forming material to form a phosphor composition; and
disposing the phosphor composition on an inner surface of the light-transmissive envelope to form a phosphor layer.

16. The method of claim 15 wherein the at least one phosphor comprises a blend of phosphors, each phosphor in said blend of phosphors may emit different colors than each other phosphor in the blend of phosphors, or the same color as one or more phosphors in the blend.

17. The method of claim 15 wherein the at least one amalgam-forming material comprises a solid which is:
(a) capable of forming an amalgam upon reaction with Hg; and
(b) which is capable of releasing Hg upon decomposition.

18. The method of claim 17 wherein the at least one amalgam-forming material comprises a powder.

19. The method of claim 15 wherein the at least one amalgam-forming material comprises at least one of In, Sn, Bi, Zn, Ag, Au, indium oxide, tin oxide, bismuth oxide, silver oxide, or zinc oxide.

20. The method of claim 15 wherein the phosphor composition comprises a ratio of from about 5 mg to about 90 mg of amalgam-forming material for every 100 g of phosphor.
